(19) United States
(12) Patent Application Publication
(10) Pub. No.: US 2026/0368340 A1
(43) Pub. Date: Nov. 19, 2026

(54) ELECTRONIC COMPONENT FOR CONNECTING A MULTITUDE OF DATA PROCESSING DEVICES TO A MODULE

(71) Applicant: WAGO Verwaltungsgesellschaft mbH, Minden (DE)

(72) Inventor: Markus WEIDNER, Minden (DE)

(73) Assignee: WAGO Verwaltungsgesellschaft mbH, Minden (DE)

(21) Appl. No.: 19/680,233

(22) Filed: May 18, 2026

(30) Foreign Application Priority Data
May 19, 2025 (DE) 10 2025 119 410.6

(51) Int. Cl. G06F 21/60

(52) U.S. Cl. CPC G06F 21/602

(57) ABSTRACT

An electronic component for connecting a multitude of data processing devices to a module which provides cryptographic services and/or cryptographic information. The electronic component comprises a first interface, configured to connect the electronic component to the module, and a multitude of second interfaces, configured to connect the data processing devices to the electronic component. The electronic component is configured to receive a request for a cryptographic service and/or cryptographic information via one of the second interfaces and to transmit the request or a request derived therefrom via the first interface to the module. Further provided is an electronic component for providing cryptographic services.

This nonprovisional application claims priority under 35 U.S.C. § 119(a) to German Patent Application No. 10 2025 119 410.6, which was filed in Germany on May. 19, 2025, and which is herein incorporated by reference.

### BACKGROUND OF THE INVENTION

### FIELD OF THE INVENTION

The present disclosure relates to an electronic component for connecting a multitude of data processing devices to a module which provides cryptographic services and/or cryptographic information, and to an electronic component for providing cryptographic services. In particular, the present disclosure relates to an electronic component with a first interface configured to connect the electronic component to the module and a multitude of second interfaces configured to connect the data processing devices to the electronic component.

### DESCRIPTION OF THE BACKGROUND ART

Cryptographic methods are increasingly used in computer-based applications to bolster security. They include, for example, the storage and provision of cryptographic information (keys, certificates), the encryption and decryption of data, the signing and authentication of data, the generation of random values, etc.

### SUMMARY OF THE INVENTION

It is therefore an object of the present invention to provide an electronic component for connecting a multitude of data processing devices to a module which provides cryptographic services and/or cryptographic information that may comprise a first interface and a multitude of second interfaces. The first interface may be configured to connect the electronic component to the module. The multitude of second interfaces may be configured to connect the data processing devices to the electronic component. The component may be configured to receive a request for a cryptographic service and/or cryptographic information via one of the second interfaces and to transmit the request or a request derived therefrom via the first interface to the module.

In this regard, the term "electronic component" can refer to a device comprising a housing and an electronic circuit arranged in the housing. The electronic circuit may be encapsulated. The electronic component may be configured to be supplied with electrical energy via first connection elements (e.g., terminals) extending through one or more first openings in the housing. The electronic component may be configured to exchange data with the data processing devices and the module via second connection elements (e.g., terminals) extending through one or more second openings in the housing.

The electronic circuit may be non-programmable or programmable. The electronic circuit may comprise a processor. The processor may execute software. The electronic circuit may be on a semiconductor chip. The semiconductor chip may be arranged in the housing. The housing may be made of insulating material. The first connection elements may be electrically conducting elements (e.g., pins). The second connection elements may be electrically conducting elements (e.g., pins) or optically conducting elements (e.g., optical fibers). The electrically conducting elements may be made of an electrically conducting material (e.g., metal such as copper, copper alloys, steel, etc.). The optically conducting elements may be made of an optical waveguide material (e.g., silica glass, polymer, etc.).

Furthermore, the term "data processing device" can refer to a device which comprises a processor and a storage in which persistently stored instructions are contained which, when executed by the processor, effect the input, processing and output of data by the data processing device (e.g., a microcontroller). For example, a data processing device may be configured to derive output data from input data and send the output data in encrypted form to a recipient.

Furthermore, the term "module that provides cryptographic services and/or cryptographic information" can refer to a module which is configured to store and provide cryptographic information (e.g., keys, certificates, etc.), to process data cryptographically, i.e., for example, to encrypt and decrypt data, to sign data, to verify the authenticity of data and/or to generate random values. In particular, the module may be configured to encrypt the derived (output) data or to provide a cryptographic key for one of the data processing devices to encrypt the derived (output) data.

Furthermore, the term "interface" can refer: one or more electrical terminals connected to a device configured to detect an electrical voltage applied to the electrical terminals or a current flowing through the electrical terminals and to derive data from the electrical voltage or current according to a predetermined interface protocol; and one or more optical connections that are connected to a device which is configured to detect light signals transmitted via the optical connections and to derive data from the light signals according to a predetermined interface protocol.

The derived data may, for example, comprise information indicating which data processing device the data originates from and which cryptographic service or cryptographic information the data processing device is requesting.

In a first example, the electronic component may not (itself) provide (any) cryptographic services, and the module may provide all (required) cryptographic services. In a second example, the electronic component may (itself) provide (all) cryptographic services and, where necessary, use cryptographic information stored in the module. In a third example, the electronic component may (itself) provide (all or some) cryptographic services and, where necessary and/or feasible, make use of cryptographic services provided by the module. The second example and the third example may be combined to a fourth example.

The wording "request derived therefrom" can refer: a request resulting from content-wise identical requests being communicated differently via the first interface than via one of the second interfaces; and/or a request resulting from the electronic component using cryptographic information and/or services of the module to fulfill the request in its entirety, partially, or not at all (by itself).

The electronic component may be configured to receive authorization information from the data processing devices when a connection is established between the data processing devices and the electronic component, and to authorize the data processing devices on the basis of the authorization information received and/or to receive authentication information from the data processing devices when the connection is established between the data processing devices and the electronic component, and to authenticate the data processing devices on the basis of the authentication information received. For example, the data processing devices may be configured to log in to the electronic component using an identifier and/or a password.

The electronic component may be configured to protect data that the electronic component exchanges with one of the data processing devices from access by other ones of the data processing devices. In particular, the second interfaces may be separated/isolated from each other in such a way that data exchanged via one interface cannot be read by devices connected to the other second interfaces.

Each of the second interfaces may comprise dedicated electrical and/or optical connections and the electronic component may be configured to input or output data that the electronic component exchanges with one of the data processing devices only via the connections of the second interface that are assigned to said data processing device.

The electronic component may be configured to reject a request for a cryptographic service and/or cryptographic information if the second interface through which the request was received is not authorized to request the cryptographic service and/or cryptographic information.

The module may comprise storage which may be configured to store authorization data, wherein the authorization data may specify which of the second interfaces or data processing devices is authorized to request certain cryptographic services and/or cryptographic information.

The configuration of the electronic component may be achieved by seeing to making the electronic component pluggable and preparing it with an external device.

The electronic component may be configured to receive the authorization data via the configuration interface and to store the authorization data in the storage. The electronic component may be configured to prohibit write access and/or read access to the authorization data via the second interfaces.

The electronic component may be configured to receive cryptographic information via a/the configuration interface and to forward the cryptographic information to the module via the first interface. The electronic component may be configured to prohibit write access to the cryptographic information via the second interfaces. The electronic component may be configured not to persistently store the forwarded cryptographic information.

The electronic component may be configured to receive authorization data via a/the configuration interface and to forward the authorization data to the module via the first interface. The authorization data may specify which of the second interfaces is authorized to request certain cryptographic services and/or cryptographic information. The electronic component may be configured to prohibit write access and/or read access to the authorization data via the second interfaces.

The component and the module may be comprised in a system. The module may comprise storage configured to store authorization data which may specify which of the second interfaces or data processing facilities is authorized to request certain cryptographic services and/or cryptographic information. The module may be configured to transmit the authorization data to the electronic component.

The module may further comprise an interface which may be used for both configuration as well as requesting and providing cryptographic services and/or cryptographic information. The module may be configured to receive authorization data and/or cryptographic information via said interface and store them in the storage. Said interface of the module may be connected to the first interface during operation. That is, once the configuration has been successfully completed, the interface may be (re-)used as the interface through which cryptographic services and/or cryptographic information are requested and provided during operation.

An electronic component for providing cryptographic services may comprise a first interface which may be configured to connect the electronic component to a storage module on which cryptographic information is stored, and a plurality of second interfaces which may be configured to connect data processing devices to the electronic component, wherein the electronic component may be configured to receive a request for a cryptographic service via one of the second interfaces and to provide the cryptographic service based on the cryptographic information received via the first interface.

Furthermore, the features described in connection with the electronic components and the system may also be features of the method in which one of the electronic components or the system may be used, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an arrangement comprising several data processing devices, an electronic component and a module which provides cryptographic services and/or cryptographic information, wherein the data processing devices are connected to the module by the electronic component;

FIG. 2 illustrates the integration of the system shown in FIG. 1 into a network;

FIGS. 3a and 3b illustrate establishing a connection between one of the data processing devices shown in FIGS. 1 and 2 and the electronic component shown in FIGS. 1 and 2;

FIG. 4 illustrates an example of the electronic component shown in FIGS. 1-3a, in which the electronic component comprises storage, which is configured to store authorization data, wherein the authorization data indicates which of the second interfaces or data processing devices is authorized to request certain cryptographic services and/or cryptographic information;

FIG. 5 illustrates an example of the electronic component shown in FIG. 4, in which the electronic component comprises a configuration interface, wherein the electronic component is configured to receive the authorization data via the configuration interface and to store the configuration data in the storage;

FIG. 6 illustrates an example of the electronic component shown in FIGS. 1-3a, in which the electronic component comprises a configuration interface, wherein the electronic component is configured to receive cryptographic information and/or authorization data via the configuration interface and forward them to the module via the first interface;

FIG. 7 illustrates an example of the module shown in FIGS. 1-3a, in which the module comprises storage configured for storing authorization data, the authorization data specifying which of the second interfaces or data processing devices is authorized to request specific cryptographic services and/or cryptographic information, and in which the module further comprises a configuration interface, wherein the module is configured to receive the authorization data and/or cryptographic information via the configuration interface and to store them in the storage;

FIG. 8 illustrates a modification of the module shown in FIG. 7, in which the configuration interface is connected to the first interface; and

FIG. 9 shows an arrangement comprising several data processing devices, a storage module in which cryptographic information is stored, and an electronic component which provides cryptographic services, wherein the electronic component is connected to the storage module.

### DETAILED DESCRIPTION

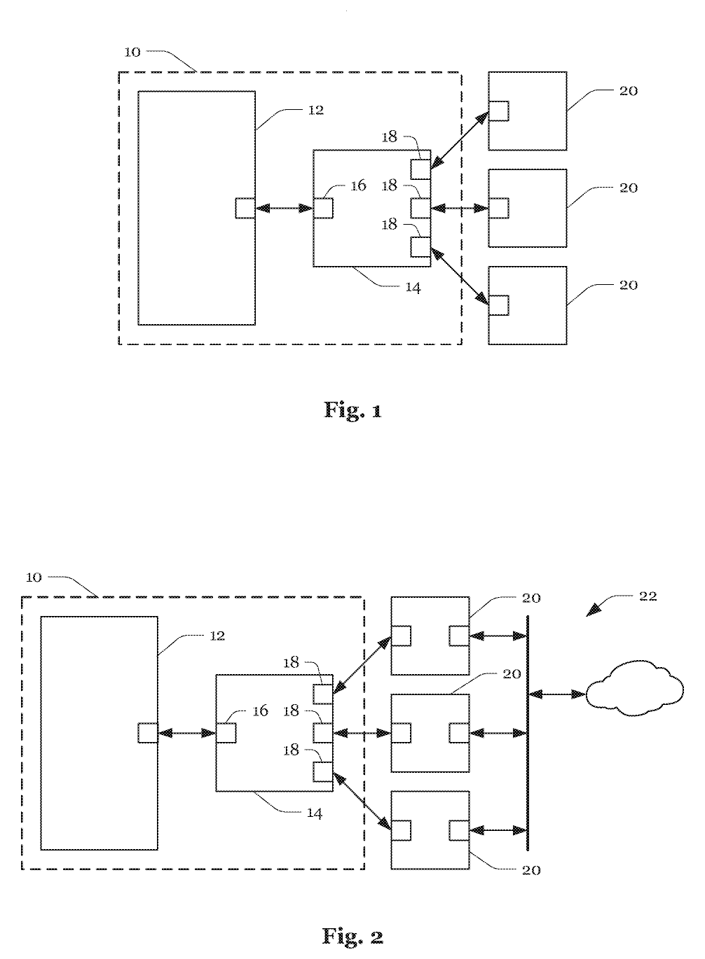

FIG. 1 shows a system 10 comprising a module 12, which provides cryptographic services and/or cryptographic information, and an electronic component 14, which is connected to the module 12 via a first interface 16 and may request the cryptographic services and/or cryptographic information via this interface. The electronic module 14 further comprises a multitude of second interfaces 18, wherein (at least) one data processing device 20 can be connected to the electronic module 14 via each of the second interfaces 18. The second interfaces 18 may be designed for the connection of a data line and may be implemented, for example, by means of separate electrical or optical connections. The circuits connected to the separate electrical or optical connections (of the electronic component 14) may be designed such that a data processing device 20 connected to a particular second interface 18 cannot access communication that takes place via other second interfaces 18.

If one of the data processing devices 20 requires a cryptographic service and/or cryptographic information, it may request them from the electronic component 14. The electronic component 14 thus enables the use of cryptographic services and/or cryptographic information by multiple data processing devices 20 without the need to add further interfaces to the module 12 or to accept that each of the data processing devices 20 can access the communication of the other data processing devices 20 with the module 12. Furthermore, the interposition of the electronic component 14, as will be explained in more detail below, allows for adding further protective mechanisms which reduce the risk of the module 12 being compromised. This may be particularly relevant if, as illustrated in FIG. 2, the data processing devices 20 are integrated into a large network 22 such as the Internet and are therefore exposed to an increased risk of attacks and attempts to compromise them.

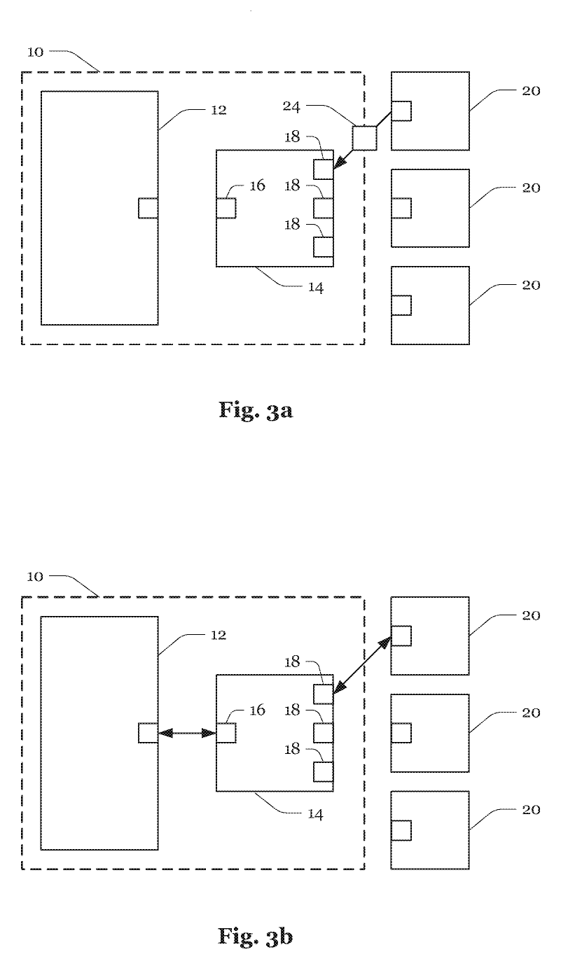

As illustrated in FIG. 3a, the electronic component 14 may require a data processing device 20 to authorize and/or authenticate itself when establishing a connection. For example, when establishing a connection, the data processing device 20 may send authentication information 24 to the electronic component 14, and the electronic component 14 may use the authentication information 24 to authenticate the data processing device 20. If the electronic component 14 is (successfully) authenticated, it may process, as illustrated in FIG. 3b, requests regarding cryptographic services and/or cryptographic information from the data processing device 20. If authentication fails, the electronic component 14 may reject requests regarding cryptographic services and/or cryptographic information from the data processing device 20.

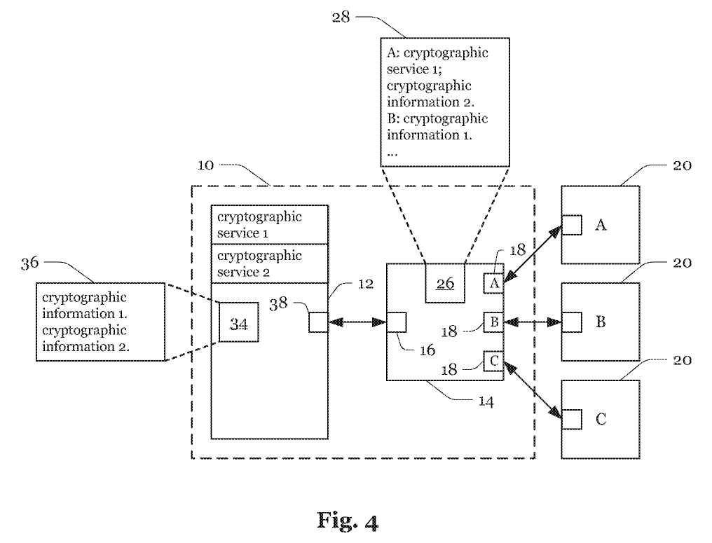

FIG. 4 illustrates an example of the electronic component 14 shown in FIGS. 1-3a, in which the electronic component 14 comprises a storage 26 which is configured to store authorization data 28, wherein the authorization data 28 directly or indirectly indicate which of the second interfaces 18 or whether the data processing device 20 connected to the respective second interface 18 is authorized to request certain cryptographic services and/or cryptographic information 36. I.e., which of the second interfaces 18 or which of the data processing devices 20 have execution rights with regard to certain cryptographic services and/or read and/or write rights with regard to certain cryptographic information. For example, the authorization data 28 may specify which cryptographic services and/or cryptographic information 36 the individual data processing devices 20 may request, and the electronic component 14 may derive from the authentication information 24 which of the second interfaces 18 the respective data processing device 20 is connected to (and thus map the authorization data 26 to the second interfaces 18).

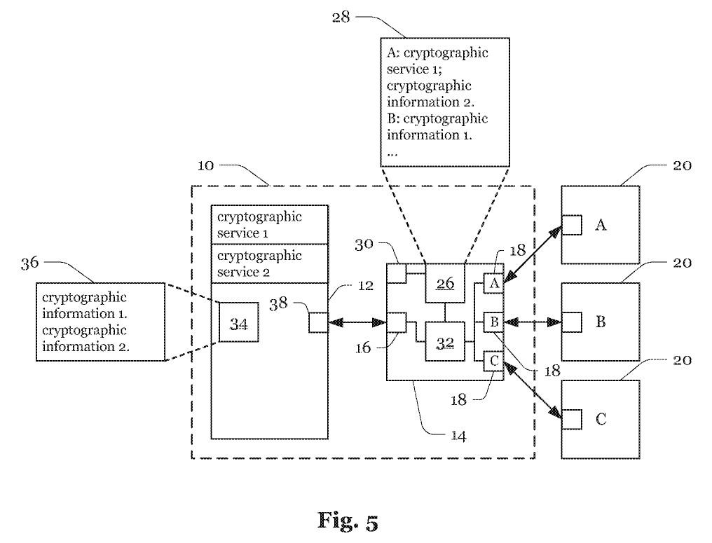

FIG. 5 illustrates an example of the electronic component 14 shown in FIG. 4, in which the electronic component 14 comprises a configuration interface 30, wherein the electronic component 14 receives the authorization data 28 via the configuration interface 30 and stores it in the storage 26. The authorization data 28 may be used during operation by a processor 32 of the electronic component 14 to control access to the cryptographic services and/or write and/or read access to the cryptographic information 36 of the module 12. Furthermore, the configuration interface 30 is protected from access by the data processing devices 20 via one of the second interfaces 18, as the configuration interface 30 is isolated from the second interfaces 18 to which the data processing devices 20 are connected. Moreover, the authorization data 28 stored in the storage 26 may be protected from access by the data processing devices 20 via one of the second interfaces 18 in that the processor 32 rejects write and/or read access to the authorization data 28 stored in the storage 26 via the second interfaces 18.

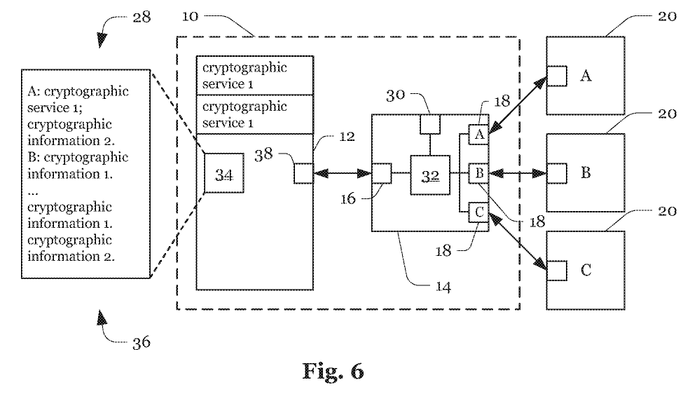

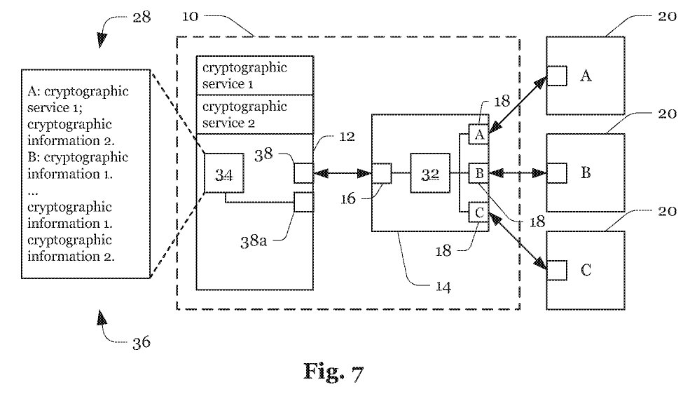

FIG. 6 illustrates an example of the electronic component 14 shown in FIGS. 1-3a, in which the electronic component 14 is configured to receive cryptographic information 36 and/or authorization data 28 via the configuration interface 30 and to forward them to the module 12 via the interface 16. In this case, the authorization data 28 may be stored in the storage 34 of the module 12 and used by the module 12 to decide which requests for cryptographic services and/or cryptographic information 36 are fulfilled by the module 12 and which requests for cryptographic services and/or cryptographic information 36 are rejected by the module 12.

Alternatively (or additionally), the electronic component 14 may be informed (possibly in response to a request) via which of the second interfaces 18 and/or from which data processing devices 20 requests for specific cryptographic services and/or cryptographic information 36 may be made (i.e., accepted). By communicating this information, the processor 32 is enabled to reject requests for certain cryptographic services and/or cryptographic information 36 via unauthorized second interfaces 18 or from unauthorized data processing devices 20.

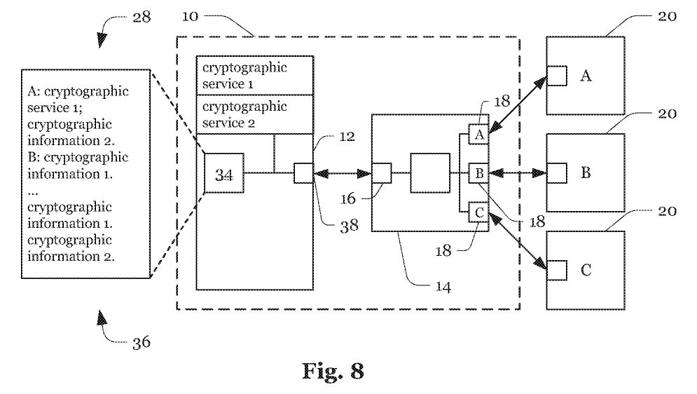

FIG. 7 illustrates an example of the module 12 shown in FIGS. 1-3a, in which the module 12 comprises a (separate) interface 38a for configuration, wherein the module 12 is configured to receive the authorization data 28 and/or cryptographic information 36 via said interface 38a and to store them in the storage 34. FIG. 8 shows a modification of the module 12 shown in FIG. 7, in which the interface 38 connected to the interface 16 also takes over the function of the interface 38a.

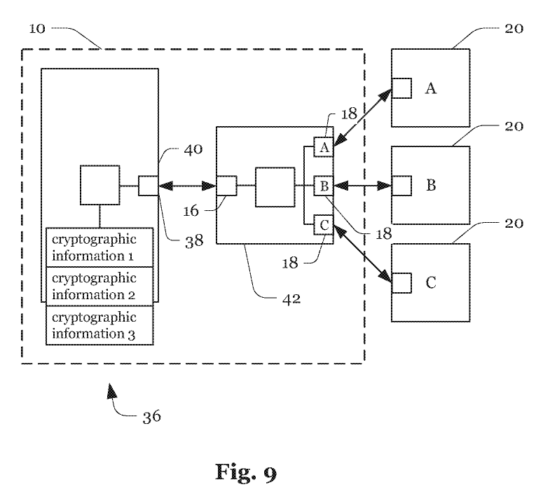

FIG. 9 shows an arrangement comprising a storage module 40, e.g. an SD card module with an SD card in it on which cryptographic information 36, e.g. cryptographic keys, is stored, an electronic component 42 connected to the storage module 40 and several data processing devices 20 which are connected to the electronic component 42. The electronic component 42 corresponds to the electronic component 14 shown in FIGS. 1-8, wherein the electronic component 42 provides all cryptographic services itself (whereas the electronic component 14 may be configured, depending on the application, to fulfill the request entirely, partially or not at all (by itself) and accordingly make use of cryptographic information and/or services of the module 12).

If the electronic component 42 receives a request for a cryptographic service via one of the interfaces 18, the electronic component 42 checks whether the request for the cryptographic service via the interface 18 or by the corresponding data processing device 20 is permitted and, if so, whether it needs cryptographic information 36 stored in the storage module 40 to provide the cryptographic service. If the electronic component 42 requires cryptographic information 36 stored in the storage module 40 to provide the cryptographic service, it requests this information via the interface 16 and provides the cryptographic service.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electronic component to connect at least two data processing devices to a module that provides cryptographic services and/or cryptographic information, the electronic component comprising:
a first interface to connect the electronic component to the module; and
at least two second interfaces to connect the at least two data processing devices to the electronic component,
wherein the electronic component is configured to receive a request for a cryptographic service and/or cryptographic information via one of the second interfaces and to transmit the request or a request derived therefrom via the first interface to the module.

2. The electronic component according to claim 1, wherein the electronic component is configured to receive authorization information from the data processing devices when a connection is established between the data processing devices and the electronic component, and to authorize the data processing devices on the basis of the authorization information received and/or to receive authentication information from the data processing devices when the connection is established between the data processing devices and the electronic component, and to authenticate the data processing devices on the basis of the authentication information received.

3. The electronic component according to claim 1, wherein the electronic component is configured to protect data which the electronic component exchanges with one of the data processing devices from access by other ones of the data processing devices.

4. The electronic component according to claim 1, wherein each of the second interfaces comprises dedicated electrical and/or optical connections and the electronic component is configured to input or output data which the electronic component exchanges with one of the data processing devices only at the connections of the second interface that are assigned to said data processing device.

5. The electronic component according to claim 1, wherein the electronic component is configured to reject a request for a cryptographic service and/or cryptographic information if the second interface through which the request was received is not authorized to request the cryptographic service and/or cryptographic information.

6. The electronic component according to claim 5, further comprising:
a storage configured to store authorization data,
wherein the authorization data specifies which of the second interfaces or data processing devices is authorized to request certain cryptographic services and/or cryptographic information.

7. The electronic component according to claim 6, further comprising:
a configuration interface,
wherein the electronic component is configured to receive the authorization data via the configuration interface and to store the authorization data in the storage, and
wherein the electronic component is configured to prevent write access and/or read access to the authorization data via the second interfaces.

8. The electronic component according to claim 5, further comprising:
a configuration interface,
wherein the electronic component is configured to receive cryptographic information via the configuration interface and to forward the cryptographic information to the module via the first interface, and
wherein the electronic component is configured to prohibit write access to the cryptographic information via the second interfaces.

9. The electronic component according to claim 5, further comprising:
a configuration interface,
wherein the electronic component is configured to receive authorization data via the configuration interface and to forward the authorization data to the module via the first interface,
wherein the authorization data specifies which of the second interfaces or data processing devices is authorized to request certain cryptographic services and/or cryptographic information, and
wherein the electronic component is configured to prevent write access and/or read access to the authorization data via the second interfaces.

10. A system comprising:
the electronic component according to claim 1; and
a module comprising a storage that is configured to store authorization data,
wherein the authorization data specifies which of the second interfaces or data processing devices is authorized to request certain cryptographic services and/or cryptographic information.

11. The system according to claim 10, wherein the module is configured to transmit the authorization data to the electronic component.

12. The system according to claim 10, wherein the module further comprises an interface, and wherein the module is configured to receive the authorization data and/or cryptographic information via the interface and to store them in the storage.

13. The system according to claim 12, wherein, during operation, the interface of the module is connected to the first interface of the electronic component.

14. An electronic component to provide cryptographic services, the electronic component comprising:
a first interface configured to connect the electronic component to a storage module on which cryptographic information is stored; and
at least two second interfaces to connect data processing devices to the electronic component,
wherein the electronic component is configured to receive a request for a cryptographic service via one of the second interfaces and to provide the cryptographic service using the cryptographic information received via the first interface.
